(19) United States
(12) Patent Application Publication
(10) Pub. No.: US 2022/0034049 A1
(43) Pub. Date: Feb. 3, 2022

(54) A SYSTEM AND METHOD FOR ASSISTING IN IMPROVING A PAVING JOB

(71) Applicant: TF-TECHNOLOGIES A/S, Fredensborg (DK)

(72) Inventors: Lisbeth Teilmann Melchior, Fredensborg (DK); Søren Kristiansen, Søborg (DK); Frank Robert Larsen, Taastrup (DK)

(21) Appl. No.: 17/419,526

(22) PCT Filed: Jan. 8, 2020
(86) PCT No.: PCT/EP2020/050288

§ 371 Date: Jun. 29, 2021

(30) Foreign Application Priority Data
Jan. 8, 2019 (EP) 19150710.2

(51) Int. Cl. E01C 23/00; G06N 5/02; G06Q 10/06; G06Q 50/08; E01C 19/48

(52) U.S. Cl. CPC E01C 23/00; G06N 5/02; E01C 19/48; G06Q 50/08; G06Q 10/0631

(57) ABSTRACT

The present invention relates to a system and method of assisting a paving vehicle e.g. an asphalt paver or the operator of such vehicle to improve a paving job performed by said vehicle. The steps performed comprises—receiving job data relating to the paving job, —receiving paving best practices data relating to any paving job, —processing the job data and the paving best practices data according to an algorithm and based thereon, generating feedback data for improving the paving job, —assisting said paving vehicle or said operator of said vehicle by making said generated feedback data available. Thereby, improved paving jobs can be performed.

### FIELD OF THE INVENTION

The invention relates to a method or system for assisting a paving vehicle e.g. an asphalt paver or the operator of such vehicle to improve a paving job performed by said vehicle.

### BACKGROUND OF THE INVENTION

When constructing paving layers on a road surface, this is done by using a paving vehicle, e.g. an asphalt paver. It is important to obtain an asphalt layer having good properties. Such properties include: a smooth surface (to provide good driving experience for cars driving on the surface), a highly compacted robust paving layer which is durable through years of wear from traffic and changing weather conditions.

In order to ensure that all these properties are obtained, it is important to ensure that the paving process or paving job is controlled in an exact manner including the control of layer width, layer thickness, operating mode of the laying tools on the paving vehicle and also the temperature and compositions of the paving material. Further, also the laying process itself, such as speed and number of stops during a laying process, can influence the quality. Not only the operation of the laying vehicle may influence the laying process and thereby the quality of the added layer, but also external parameters influence the quality. A paving process should e.g. be performed in a different manner in a cold and windy environment and a warm and calm environment respectively, to obtain a similar paving job quality.

It is known to measure data locally during a paving process. A range of different input sensors mounted on the asphalt paver do this. Such data is measured to keep track of material consumption to document how many kg have been put down per m² paved or by registering instances of stop, start and loading to document the paving work flow. Further data, which that is measured, is paving speed, paved distance and material temperature. It is also known that all such measured data can be tracked with exact time and location coordinates and can then be used for data processing and analysis e.g. to deliver a printed report of key data to validate that road specifications of a particular road paving job on a particular stretch of road have been met.

It is the aim of the current invention to find a way of improving the paving process ensuring that the quality of the paving layer is improved.

### SUMMARY OF THE INVENTION

An improved way of paving is obtained by the invention defined in the claims.

In accordance with the invention, there is provided a method of assisting a paving vehicle e.g. an asphalt paver or the operator of such vehicle to improve a paving job performed by said vehicle, wherein said method comprises
receiving job data relating to said paving job,
receiving paving best practices data, said best practice data comprising one or more of the following types of data: Process data from the current paving job, data collected from previous paving jobs, and/or external data,
processing said job data and said paving best practices data according to an algorithm and based on said processing generating feedback data for improving said paving job,
assisting said paving vehicle or said operator of said vehicle by making said generated feedback data available.

In accordance with a variant of the invention, there is provided a method of assisting a paving vehicle e.g. an asphalt paver or the operator of such vehicle to improve a paving job performed by said vehicle, wherein said method comprises
receiving job data relating to said paving job,
receiving paving best practices data,
processing said job data and said paving best practices data according to an algorithm and based on said processing generating feedback data for improving said paving job,
assisting said paving vehicle or said operator of said vehicle by making said generated feedback data available.

In accordance with a preferred embodiment of the invention, there is provided a method of assisting an asphalt paver or the operator of such an asphalt paver to improve a paving job performed by said asphalt paver, wherein said method comprises
receiving job data relating to said paving job,
receiving paving best practices data,
processing said job data and said paving best practices data according to an algorithm and based on said processing generating feedback data for improving said paving job,
   assisting said asphalt paver or said operator of said asphalt paver by making said generated feedback data available.

Throughout this document, the words paving job and paving process are used covering the same meaning.

Throughout this document, when a data transfer is described, then it is to be understood that this could be either via wires or wireless using a wireless communication network such as a public or private communication network.

Throughout this document, a method for a paving vehicles is described, and preferably this method is employed to an asphalt paver being the preferred embodiment of the paving vehicle.

In this description, data measurement devices, data collection units and a central server for handling the data for generating feedback are described. The geographic position of these elements is not important. It is only relevant that data is measured and centrally collected for processing and generating a feedback.

Throughout this document, the term best practice data is used to describe the ideal parameters to adhere to under the specific conditions of the situation in which the road paving vehicle, preferably an asphalt paver, is operating. The best practice data is based on a combination of process data from the current paving job, data collected from previous paving jobs, and external data.

In accordance with the invention, there is provided a method of assisting a paving vehicle e.g. an asphalt paver or the operator of such vehicle to improve a paving job performed by said vehicle, wherein said method comprises
receiving job data relating to said paving job,
receiving paving best practices data, said best practice data comprising process data from the current paving job, data collected from previous paving jobs, and external data,
processing said job data and said paving best practices data according to an algorithm and based on said processing generating feedback data for improving said paving job,
assisting said paving vehicle or said operator of said vehicle by making said generated feedback data available.

In accordance with a preferred embodiment of the invention, there is provided a method of assisting an asphalt paver or the operator of such an asphalt paver to improve a paving job performed by said asphalt paver, wherein said method comprises
receiving job data relating to said paving job,
receiving paving best practices data, said best practice data comprising process data from the current paving job, data collected from previous paving jobs, and external data,
processing said job data and said paving best practices data according to an algorithm and based on said processing generating feedback data for improving said paving job,
   assisting said asphalt paver or said operator of said asphalt paver by making said generated feedback data available.

Process data of the current paving job is the data which can be collected while the paving job is taking place. It includes, but is not limited to, data measured on or from the paving vehicle, e.g. speed of the machine, temperature of the paving material, ambient temperature, windspeed, speed of deposition of the paving material.

The data collected from previous paving jobs includes a collection of data from situations, where at least one condition was in common, e.g. the same paving material was used, the same asphalt paver was used, weather conditions were similar. This data includes both the operating conditions and data collected to evaluate the result of the procedure. By collecting the data from many jobs with overlapping parameters, it is possible to derive statistics on how various parameters and conditions affect the pavement resulting from the pavement job. This is the benefit of so-called big data processing.

The best practice data also includes relevant external data, which is to be understood as parameters and conditions set by third parties as well as data collected by third parties independently of specific operations of the paving machine or the paving job itself. Such external data may include, but is not limited to, such things as rules set by the local authorities regarding noise level or vehicle speed, weather conditions such as weather forecasts or amount of precipitation, material information on the properties of the pavement as delivered, specification on the work team such as their experience level number of operators present, and knowledge of any previous treatment of the job site. This information constitutes parameters which cannot be changed for the particular paving job, but which will still be imposing limits and state how the paving job should be executed to get the best possible results. Hence, these are also part of the best practice data which the collected job data will be related to and in view of which the feedback data will be generated.

In accordance with the invention, there is provided a method of assisting a paving vehicle e.g. an asphalt paver or the operator of such vehicle, wherein the best practice data comprises data from the current paving job, data collected from previous paving jobs, and external data provided by third parties.

In accordance with the invention, there is provided a method of assisting a paving vehicle e.g. an asphalt paver or the operator of such vehicle, wherein the best practice data comprises data regarding environmental impact of the paving job.

Paving of asphalt is essential for infrastructure, but as with every other construction and production it is a process that has an impact on the environment and climate. To be able to minimise any adverse effects of such an impact, it is beneficial to take into account the impact of as many steps of the process as possible. This includes collecting process data regarding the impact during the paving job, e.g. CO₂ emissions, energy usage, water consumption, and creation of waste. Furthermore, it includes taking into account the same parameters during the production of the paving material.

Collecting such data and including it in the best practice allows the feedback created by the method to guide the process in a way that minimises the environmental impact. An example could be relating the heating of the material and the speed so that least fuel must be used.

Furthermore, collecting and correlating such data may allow evaluation and choice of material and machines in combination which cause the lowest environmental impact. For example, some materials may produce less CO₂ to produce but may still lead to a higher overall CO₂ footprint in the paving process, if they need to be heated to a higher temperature to be possible to apply during the paving job.

### SHORT LIST OF THE DRAWINGS

In the following, example embodiments are described according to the invention, where

FIG. 1 illustrates job data collected from a paving vehicle,

FIG. 2 illustrates collected external job data,

FIG. 3 illustrates paving best practice data used for improving the result of a paving job,

FIG. 4 illustrates a system for assisting a paving vehicle,

FIG. 5 illustrates a method for assisting a paving vehicle.

### DETAILED DESCRIPTION OF DRAWINGS

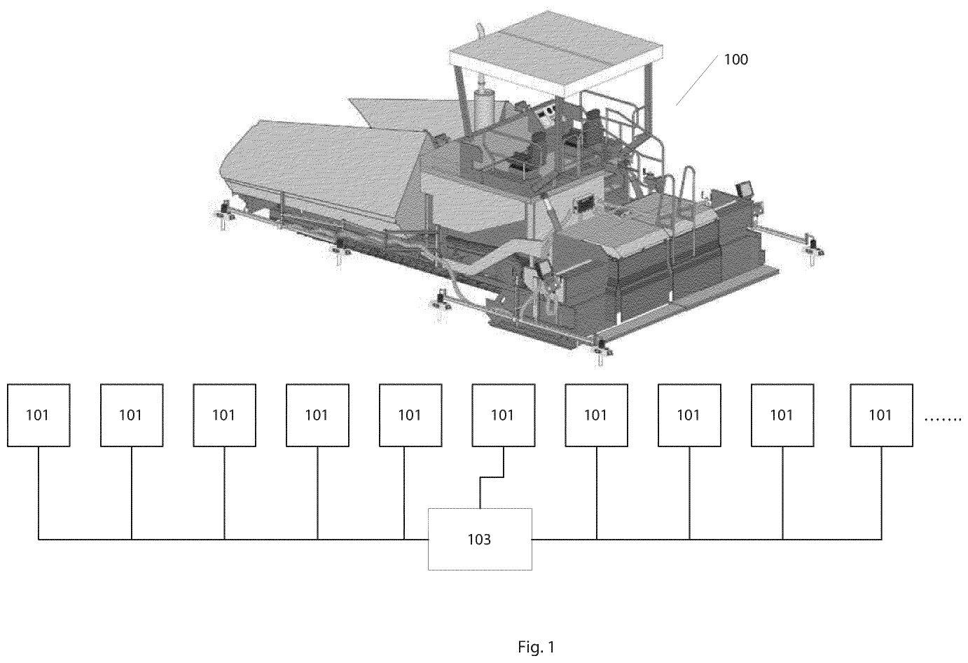

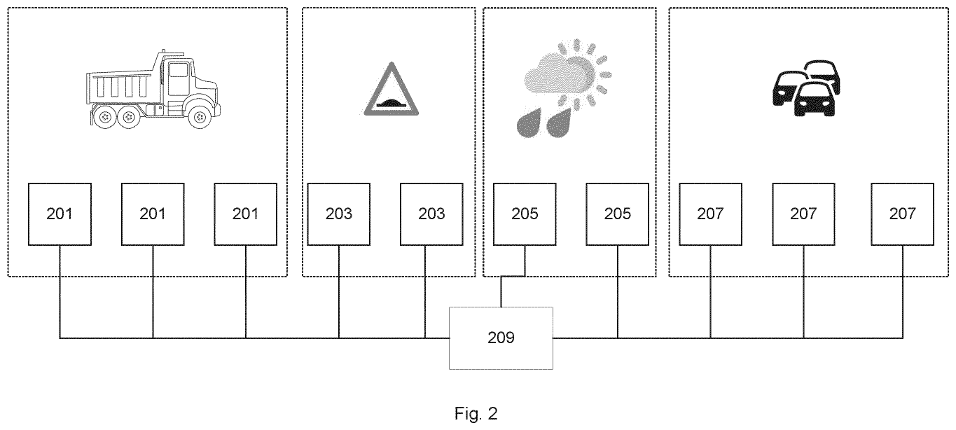

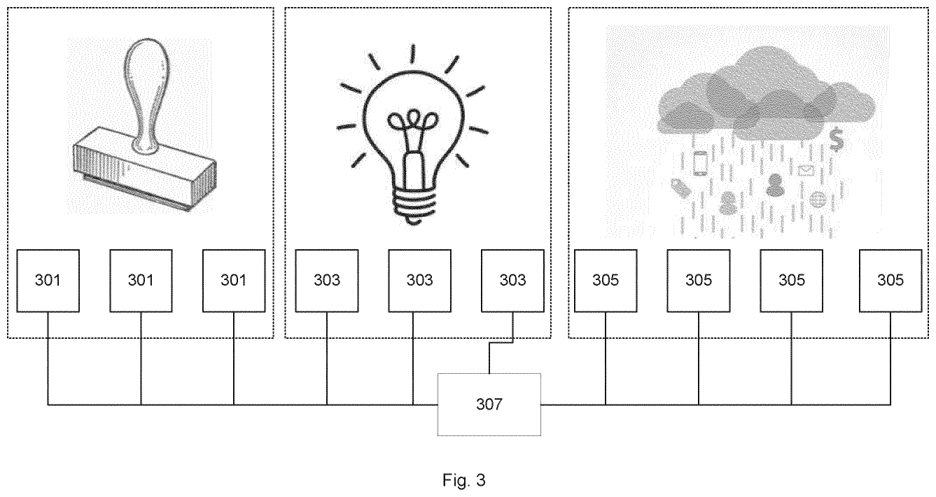

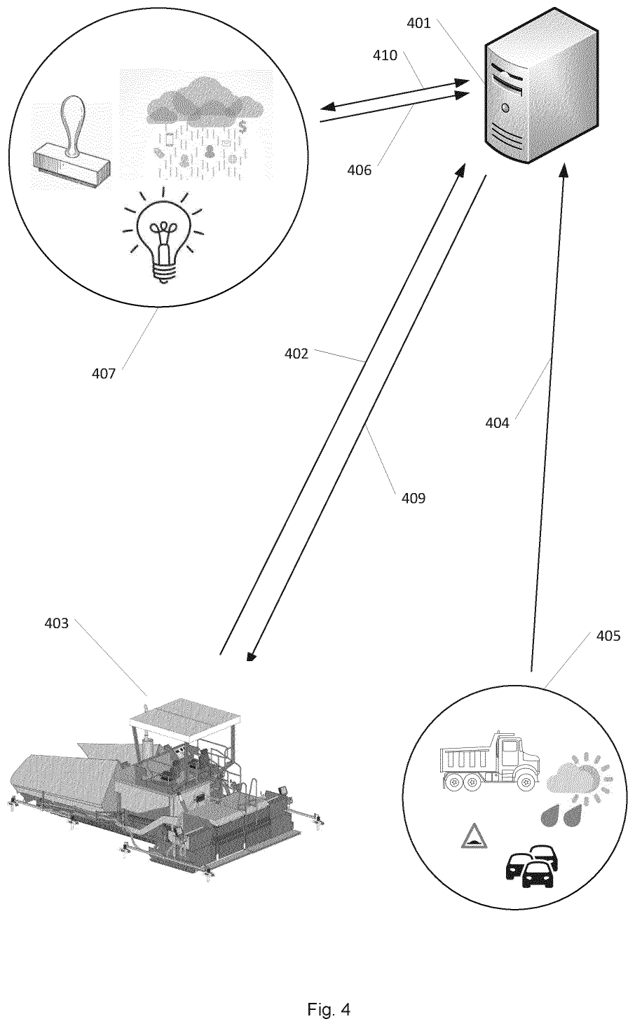

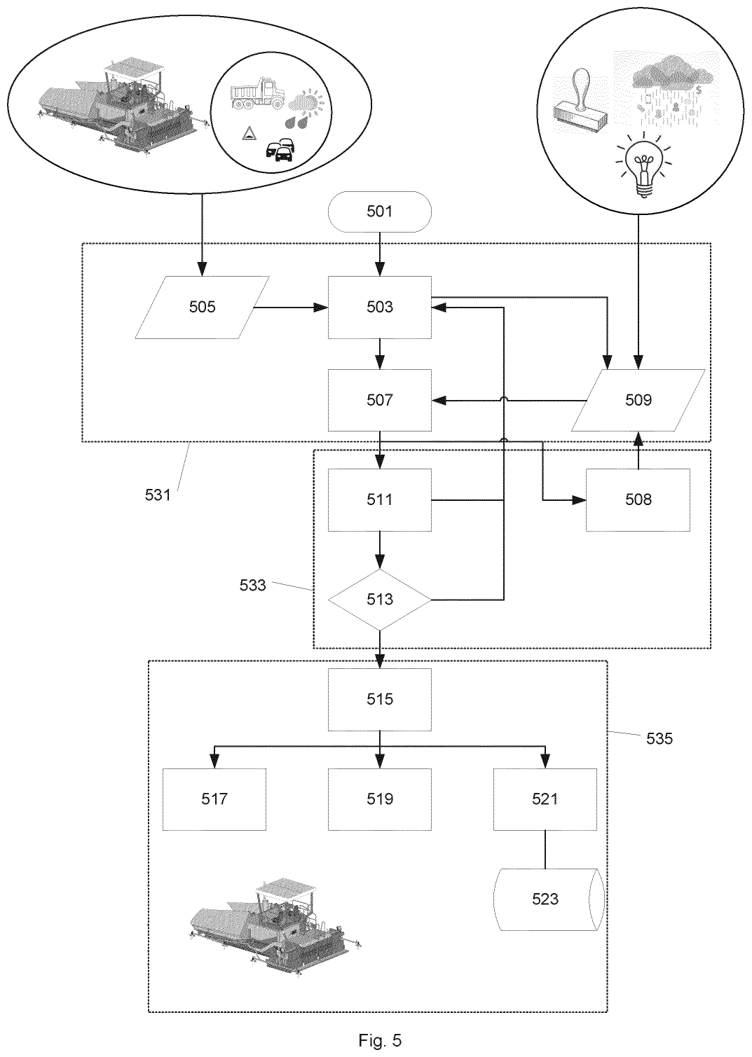

The method of the present invention relates to the following steps and similarly, the system comprises elements for performing the following steps:
1. Collecting job data being data-specific for the paving job either being performed or to be performed, and such job data could either be related to the operating status of the paving vehicle (FIG. 1) or locally measured material or surface properties, or the data could be external job data influencing the result of the current paving job (FIG. 2).
2. The collected data is then analysed (FIG. 4 and FIG. 5) e.g. by comparing the data to paving best practice data (FIG. 3).
3. Based on the analysis as described above, a feedback is generated (FIGS. 4 and 5) relating to the specific paving job,
4. The feedback is made available to the paving vehicle used in the paving job or the operator of the paving vehicle with the purpose of improving the paving job.

In a preferred embodiment of the invention, the paving vehicle for which data on the operating status is collected in step 1 above and to which feedback is subsequently made available in step 4 above is an asphalt paver.

The collected job data could be both data measured at the paving vehicle relating to the operating status of the paving vehicle and/or the paving material properties, and it could also be data describing external job parameters measured away from the paving vehicle but still influencing the current paving job.

In a preferred embodiment of the invention, the best practice data comprises both the job data or process data measured at the paving vehicle, said paving vehicle being an asphalt paver in a preferred embodiment, both for the present job and from a collection of previous paving jobs and external data collected from one or more third parties.

In FIG. 1 a paving vehicle 100 is illustrated. The vehicle comprises a data collection unit 103 connected to a number of measurement devices 101, where each measurement device is adapted to measure a specific type of job data for measuring the operating status of the vehicle or parameters relating to the vicinity of the vehicle such as surface or material properties or properties of the environment. The measurement devices 101 could be set up to communicate the job data to a data collection unit 103. The data collection unit 103 could be positioned locally at the paving vehicle 100 but as an alternative, a data collection unit 103 could also be positioned away from the vehicle 100, whereby at least some of the measurement devices 101 could be adapted to communicate the measured data to the data collection unit positioned away from the paving vehicle. As a specific embodiment, a number of data could be collected and stored locally at a data collection unit 103 positioned at the paving vehicle, whereas other data could be communicated to a central data collection unit 103 positioned away from the paving vehicle 100.

In a preferred embodiment of the invention, the paving vehicle 100 is an asphalt paver as depicted in FIG. 1. The asphalt paver 100 comprises a data collection unit 103 connected to a number of measurement devices 101, where each measurement device is adapted to measure a specific type of job data for measuring the operating status of the asphalt paver or parameters relating to the vicinity of the asphalt paver such as surface or material properties or properties of the environment. The measurement devices 101 could be set up to communicate the job data to a data collection unit 103. The data collection unit 103 could be positioned locally at the asphalt paver 100 but as an alternative, a data collection unit 103 could also be positioned away from the asphalt paver 100, whereby at least some of the measurement devices 101 could be adapted to communicate the measured data to the data collection unit positioned away from the asphalt paver 100. As a specific embodiment, a number of data could be collected and stored locally at a data collection unit 103 positioned at the asphalt paver 100, whereas other data could be communicated to a central data collection unit 103 positioned away from the asphalt paver 100.

A paving vehicle comprises at least one or more of the following elements, where data could be measured to improve the paving job:
Paving material storage for storing the material,
paving material conveyor transporting material from storage to screed,
auger for distributing material across the screed,
tamper for compacting the material in front of the screed,
vibrator for compacting the paved material positioned on the surface,
tow points for the screed for adjusting attack angle of the screed.

Such a paving vehicle is in a preferred embodiment an asphalt paver having the same elements as listed above, where data could be measured to improve the paving job.

Examples of job data or paving process data measured at the vehicle by a measurement device 101 either related to the operating status or measuring parameters in the vicinity of the vehicle could be the data described below:

Temperature Data (which could Influence the Paving Process Either Directly or Indirectly), Such as:
Temperature of the paving material positioned in the paving vehicle,
temperature of the paved surface behind the screed,
temperature of the air surrounding the paving vehicle (local weather temperature),
temperature of different parts of the paving vehicle such as screed temperature.

A temperature measurement device, e.g. a thermometer element positioned locally at positions where temperature data is to be collected, collects the temperature data.

### Vibrator Data, Such as

Vibration frequency,
Vibration intensity.

Vibrator data measurement devices for measuring vibrator data collect the vibrator data.

### Tamper Data, Such as

Tamper frequency.

Tamper data measurement devices for measuring tamper data collect the tamper data.

Other Data, which could be Collected by Measurement Devices at the Paving Vehicle, could be:
Material flow, e.g. measured as conveying activity, i.e. by an conveyor sensor,
material level in front of the screed measured at the auger, i.e. by an auger sensor,
paving speed describing how fast the paving layer is being applied to the surface, e.g. by a speed measuring device,
truck docking by a proximity sensor at the front of the paving vehicle,
time, position and orientation of the paving vehicle, e.g. by means of GNSS system,
data about mechanical parts on the paving vehicle, such as auger position, side plate position, crown position, hopper flaps position, tow point position, e.g. by electromechanical linear or angular sensors, transducers or encoders.

All the measurement devices 101 at the paving vehicle could be connected directly or indirectly to a local data collection unit 103 comprising a data storage and also a data processing unit controlling the data collection process (such as collection frequency) and maybe also for converting collected data into a predefined format. After collection, the data stored in the data storage of the local collection unit could be transferred to a central data collection device, and this transfer could be done via wireless communication e.g. using the telecommunication network, or it could be done by using a memory device (e.g. a memory stick).

The same connection between the measurement devices 101 and a local data collection unit 103 comprising a data storage and a data processing unit controlling the data collection process and which may also convert the collected data into predetermined formats is used in the preferred embodiment, where the paving vehicle is an asphalt paver.

Paving job data could also be collected relating to external job data which could e.g. somehow influence the paving job performed by the paving vehicle.

Paving job data may in embodiments of the invention include data on how close the system comes to the best practice data. Any variations may be tracked to further determine parameters influencing deviations. Trends in deviation between process data and best practice data may help further change the best practice data to compensate for such deviation.

FIG. 2 illustrates collected external job data, where a data collection unit 209 is communicatively connected to a number of data providers in the form of data services or measurement devices 201, 203, 205, 207, where each data provider is adapted to provide a specific type of external job data.

This external data may be related specifically to paving jobs, e.g. be restrictions set down by the local authority, or it may be independent data, e.g. weather forecasts.

The data provider 201, 203, 205, 207 could be set up to communicate the data to a data collection unit 209. The data collection unit 209 could be positioned locally at the paving vehicle, but as an alternative the data collection unit 209 could also be positioned away from the vehicle, whereby at least some of the data providers 201, 203, 205, 207 could be adapted to communicate the provided data to the data collection unit positioned away from the paving vehicle. As an embodiment, some data could be collected and stored locally at a data collection unit 209 positioned at the paving vehicle, whereas other data could be communicated to a central data collection unit 209 positioned away from the paving vehicle.

Examples of job data or paving process data measured away from the paving vehicle could be the data listed below:

Truck data 201 relating to the truck delivering paving material to the paving vehicle, such as truck position, could be data describing the truck load (such as temperature or amount of paving material on the truck) and truck speed. The truck could be equipped with measurement units for measuring the data and then communicating the data. The data could be communicated directly to the central data collection unit, where the data is linked to other data relating to a specific paving job or could be communicated to the local data collection unit and stored together with other data relating to the specific paving job.

Truck data 201 could further comprise information about the number of trucks present on the site or on their way to the site. It could include GPS data to allow easily keeping track of delays and position of the trucks. It could further comprise information about the type of trucks used, e.g. build, age, the size of the barrel stand, shape of the barrel stand, and/or if the barrel stand is isolated. Further, in some variations of the invention, there may be information regarding the weight of the truck with and without the load to be delivered.

Other External Data could be:
Weather forecast data 205,
traffic data 207,
road condition data 203, e.g. profilograph data.

### Additional External Data Includes:

Specific type of paving job,
external material data,
road/job site measurements,
work team data,
data on site-preparation,
resources available at the site,
roller information,
environmental data.

The external data 201, 203, 205, 207 is measured by measurement units or provided by data services and then communicated either directly to the central data collection unit, where the data is linked to other data relating to a specific paving job, or the data is communicated to the local data collection unit and stored together with other data relating to the specific paving job. Later, all data could then be transferred to the central data collection unit as described above.

A further example of job data could be test results, where features of an already applied paving layer is measured, and such features could be measured by performing an analysis of the profilograph of the applied layer, an analysis of test drills in the applied layer or by density gauge measurements.

In the above, examples have been given on different types of job data, being data specific for the paving job either being performed or to be performed. This data could e.g. either be related to the operating status of the paving vehicle (FIG. 1), data relating to the paving material, data relating to the surroundings of the paving vehicle, external data influencing the result of the current paving job (FIG. 2) or quality measures of the applied paving layer.

According to the present invention, at least some of the data is then to be analysed and in some manner compared or processed with respect to paving best practice data for providing feedback data.

Further examples of job data and how they could contribute to the pest practice data is elaborated on below:

Paving job data may include such information of what type of road is being paved, e.g. highway, countryside, city roads or suburban roads. It may include set parameters for the layer to be paved such as, but not limited to, the intended thickness, if it is to be a noise reducing pavement, and if there will be structuring of the road surface. This may also include the type of material to be laid out.

Such paving job data may be linked to rules set down by the local road directorate specifying conditions that must be met when working with the relevant materials or at the relevant sites. Such external data may be included in the best practice data to set limits to the values that the operation parameters can take.

External material data may include data from the manufacturer. This may be specifications such as what the minimum, maximum, and nominal temperatures for working with the material are. Further material information may include to what extend the material can be compressed and in what temperature range this is possible to achieve.

External material data may also include data collected at the pavement production plant to give more knowledge about the previous treatment of the material for the specific paving job. Such specific external material data may include the processing temperatures registered during the production of the paving material. Another specific external material data is the temperature of the paving material when it was shipped from the production facility or when it was loaded onto the truck. Yet another external material parameter that could be included in the data set is the recipe used to obtain the material, including the composition of the material and the processing steps involved in making it.

Weather information may include weather forecasts facilitate planning for any expected changes in the conditions at the working site. Weather information may also include the current weather conditions at the site of the paving job, e.g. the amount of precipitation may influence for how long work can be continued in the region. Similarly, information about whether it is sunny or overcast may influence the best practice data.

External data regarding road and job site information may include measurements made at the site, before the actual paving job takes place. Such measurements may include non-destructive measurements that could e.g. be made with a ground penetrating radar. Such non-destructive measurements may include density measurements, composition measurement, e.g. detecting the presence of cracks in the old asphalt, and humidity measurements of the material underneath, e.g. gravel or old asphalt.

Further, it may include data regarding the structure of the underlying surface, e.g. the slope or the evenness of the surface before paving.

External data regarding road and job site information may also include measurements made at the site after the actual paving job has been carried out. Such measurements allow evaluation of the procedure and the quality of the produced paving mat. Such measurements may include drill core or non-destructive measurements of road that has been paved to obtain data regarding, e.g. the density of the paved material. Another type of job data, which may be collected after the paving job has been performed, is profile measurements carried out to obtain an assessment of the evenness of the paved mat. Such external data measured after the paving job has been performed may also include friction measurements of the paved mat.

External data may also include information about the team working on the site. This may include such data as the number of people present at any given time. Team data may also include information about members of the team, e.g. their experience level with the available types of equipment. Such external data regarding the team members may also include personal preferences such that the feedback provided by the system is tailored to the present team.

External data may include information of the preparation of the job site prior to the paving job itself taking place. Such data may include information on the spraying process having taken place in preparation for the paving. Information on this process may include the type of emulsion or binding agent used as well as the amount of liquid used either in total or per area.

External data regarding the available resources at the job site may include type of paver present, the type of screed present, the type and number of rollers, and the type of spraying vehicle.

External data may also include process data of the roller. Such data for the roller may include the pattern in which it is driving, and the number of passes made by the roller. Further data regarding the rolling process may include the temperature of the material, when the rolling was performed.

External data may also include information regarding environmental aspects of the process. Such environmental external data may include the CO₂ footprint of either of the aspects of the paving job or a full CO₂ lifecycle analysis. Specific recordings, either measured or estimated, of the CO₂ emissions may be for the production of the paving material, for the energy consumption during the paving process, for the energy consumption of the delivery of materials to the job site, for the paving machine, for other machines present at the job site. Further, environmental data may include the emission of chemicals during the paving process. Another type of environmental data may include water consumption for different paving materials and processes during the paving job.

Other environmental external data may include the noise level during different paving processes.

In one embodiment of the invention, best practice data is based on a combination of available data of all of the above-mentioned categories. In other embodiments of the invention, only some of the external data will be included in the analysis. Although more data will lead to more accurate best practice data, a larger amount of data will require more processing power to determine the preferred parameters based on which to assist the pavement job. In a preferred embodiment, at least one type of external data is included in the best practice data.

FIG. 3 illustrates paving best practice data which can be used and combined with job data for generating a feedback.

A data collection unit 307 is connected to a number of data collection devices 301, 303, 305, where each data collection device collects a specific type of paving best practice data. The data collection unit 307 could be positioned locally at the paving vehicle but as an alternative, the data collection unit 307 could also be positioned away from the vehicle, whereby at least some of the data collection devices 301, 303, 305 could be adapted to communicate the measured data to the data collection unit positioned away from the paving vehicle. As an embodiment, some data could be collected and stored locally at a data collection unit 307 positioned at the paving vehicle, whereas other data could be communicated to a central data collection unit 307 positioned away from the paving vehicle.

In a preferred embodiment, a data collection unit 307 is connected to a number of data collection devices 301, 303, 305, where each data collection device collects a specific type of paving best practice data. The data collection unit 307 could be positioned locally at the asphalt paver but as an alternative, the data collection unit 307 could also be positioned away from the asphalt paver, whereby at least some of the data collection devices 301, 303, 305 could be adapted to communicate the measured data to the data collection unit positioned away from the asphalt paver. As an embodiment, some data could be collected and stored locally at a data collection unit 307 positioned at the asphalt paver, whereas other data could be communicated to a central data collection unit 307 positioned away from the asphalt paver.

The collection units could collect data relating to either known process standards 301, existing paving knowledge 303 or data from other paving jobs performed globally and possible data related to learnings from these 305 (Big data).

Data relating to known process standards 301 could relate to predefined paving criteria/standards that the paving job should live up to, and this could be criteria such as:
Acceptable number of stops/distance,
acceptable length of stops,
acceptable temperature of material,
minimum/maximum paving speed,
mat width.

Such standard could have been defined by local regulations, customer demands/designs or they could be defined as the paving companies best practices. In specific, embodiment standards are defined individually per paving job.

Data relating to existing paving knowledge 303 could relate to experience from other paving jobs both obtained by using the specific paving vehicle, but also by experience from using similar vehicles globally or from paving jobs in similar conditions. The best practice data could be globally collected paving knowledge and could e.g. relate to experience as follows:
Short stops result in bumps in paved mat,
longer stops result in material cooling,
cooler material means that material is more difficult to compact,
wet conditions mean poor quality mat,
relations between tamper/vibrator/paving speed parameters and quality of paving mat.

Big data and data relating to an analysis of big data 305 (globally collected data regarding paving jobs) and examples of such analysis could be performed as e.g.:
Deep Learning (AI)
Neural Networks
Statistical analysis
Trend analysis
Pattern recognition

Every time new data is added (from e.g. 103, 209 and 307) to big data collections, the data could be analysed to find new correlations or patterns in the data. The resulting data collected by 305 includes therefore improved understanding of best practice and improved algorithms.

Big data systems may include many types of data relevant to the paving job including process data from the present paving job, process data or job data from previous jobs and external data provided from third parties. Big data systems have the benefit of including and relating many parameters to obtain statistical relations between the effect of the parameters in combination and alone.

In an embodiment of the invention, best practice data will be based on big data regarding many different types of pavers, material and site conditions. The best practice data will then be extracted through an analysis of all of these parameters. In an embodiment of the invention, data obtained from conditions similar to the ones of the present paving job will have a heavier weighing than those for jobs with other conditions. In a preferred embodiment of the invention it is possible to adjust which parameters and conditions are most important for the present job in determining the best practice data.

In an embodiment of the invention, the parts of the big data set to be used in the best practice data may be chosen specifically for each job site.

In an embodiment of the invention, adjustments to the feedback data are made in real time such that constant reevaluation is performed relating the process data to the best practice data. In an embodiment of the invention, the best practice data is updated in real time by implementing the information process information obtained at the job site. In this manner, the process data may help ascertain which of the big data is most relevant for the best practice data.

In an embodiment of the invention, known or estimated information regarding the job site is specified before the beginning of the paving process. Once the paving process begins, process data is collected and new information is gained about the job site. From this the feedback, data is updated during operation, as the job data is updated and the algorithm relates it to the best practice data.

FIG. 4 illustrates a system for improving a paving job according to the present invention combining job data and paving best practice data for generating a feedback and making it available for improving the paving job. The system comprises a central server unit 401 for processing collected data, and the central server 401 receives input 402 from measurement devices 101 (FIG. 1) measuring data relating to the operation of the paving vehicle 403. The central server 401 also receives input 404 from measurement devices 201, 203, 205, 207 (FIG. 2) adapted to measure a specific type of external job data 405. Further, the central server also receives input 406 from data collection devices 301, 303, 305 (FIG. 3) collecting paving best practice data 407. The data from the measurement devices and the data collection devices could also be transmitted indirectly via the data collection units 103, 209, 307.

The central server unit comprises a processing unit, means for receiving and transmitting data and also means for storing data.

The central server unit 401 processes this data 401 e.g. by analysing the collected data received via 402 and 404 and comparing them to the best practice paving data received via 406. Based on the analysis as described above, a feedback 409 is generated relating to the specific paving job with the purpose of improving the paving job.

Further, the central server unit 401 could process this data 401 e.g. by Big data analysis to generate possible new relations between data 402, 404 and/or 406.

These new relations 410 could e.g. become part of data 305 in paving best practice data 407.

In FIG. 5, the method of assisting the paving vehicle is illustrated. The method comprises a data collection process 531, a data analysis process 533 and a feedback process 535.

In a preferred embodiment of the invention, the paving vehicle to be assisted by the method illustrated in FIG. 5 is an asphalt paver.

In 501, a paving job is initiated and then the data collection process 531 is started, where paving vehicle data and external paving job specific data 505 is obtained in 503, and in 507 the paving best practice data 509 is obtained. In an embodiment, the job specific data is constantly read during the paving process, whereas the paving best practice data could be read once prior to the beginning of a paving job and according to specifics of the paving job to be performed. Alternatively, the paving best practice data could also be read based on the job specific details. E.g. if the conditions are cold and windy, the paving best practice data relating to cold and windy conditions are read.

As part of the data collection 503, paving vehicle data and external paving job specific data 505 is added to the paving best practice data 509 as globally collected paving job data 305.

In 508, data is processed for finding new possible learnings, e.g. by updating neural networks weights e.g. through a recursive training session with the new paving vehicle data and external paving job specific data 505.

In 511, the data is analysed and it is determined whether feedback data should be generated to improve the paving job. If feedback data is generated in 513, then the process moves on to the feedback process 535 and if not, the process returns back to the data collection process. The analysis in 511 could e.g. be an evaluation of a neural network from best practice data 509 trained in 508. Alternatively, the analysis in 511 could also e.g. be a simple test of measured data from 505 against allowed values in standards from 509.

The analysis as described above could e.g. be performed according to the following, potentially resulting in feedback which could improve the paving process:
Processing of current paving job process data 505 through AI/Neural networks based on general paving data 509,
evaluation of current paving job process data 505 through fuzzy rulesets based on general paving data 509,
making recommendation from algorithms based on general paving data 509,
direct evaluation of process data 505 against standard algorithms (paving best practice data 509) for best paving practices developed from existing paving knowledge,
Direct evaluation of process data 505 against algorithms (general paving data 509) for best paving practices defined by standards defined by local regulations, customer demands/design or paving company best practices.

In 515, it is determined if the generated feedback should be made available to the operator as instructions and/or converted to a control signal and/or stored at a recommendation database as recommendation data for future operations.

If the feedback data is to be made available as operator instructions, then the feedback data is converted in 517 to operating instructions and communicated to the operator of the paving vehicle.

Operator instructions could e.g. be recommendations/instructions to the operator of the paving vehicle improving the current paving job such as:
Slow down the paving speed to match next truck with paving material,
lower the paving material level in front of the screed,
adjust screed temperature,
Send recommendations for compactor driving pattern and/or location.

This feedback could e.g. be given to the operator via a screen positioned on the paving vehicle.

If the feedback data is to be converted to a control signal controlling the paving vehicle, then the feedback data is converted in 519 to control data and provided as control data to the paving vehicle for controlling said paving vehicle.

The control signal could e.g. control the vehicle to
adjust paver speed up/down,
adjust auger speed,
adjust vibrator/tamper parameters,
adjust position of such mechanical parts of the paving vehicle, such as side plates, hopper flaps or tow points.

The control signal is sent directly or indirectly to the control system of the paving vehicle.

If the feedback data is to be stored as recommendation data, then recommendation data is generated in 521 based on said feedback data and stored at a recommendation database 523 at least being accessible by the operator.

Thereby, the recommendation database comprises recommendations for future jobs such as:
Use more trucks so lengthy stops are avoided,
pave more slowly to match flow of trucks,
material levels being high—could result in temperature segregation,
compaction may be affected by process settings,
use different levelling sensor setup for this type of job,
train vehicle operators in using leveling system,
train operators in material management.

Additional recommendations for future jobs may relate to the choice of material and treatment to minimise the environmental impact of the paving job taking into account as much of the life cycle as possible.

1. A method of assisting a paving vehicle to improve a paving job performed by said vehicle, the method comprising:
receiving job data relating to said paving job; receiving paving best practices data, said best practice data comprising one or more of the following types of data: process data from the current paving job, data collected from previous paving jobs, and/or external data;
processing said job data and said paving best practices data according to an algorithm and based on said processing generating feedback data for improving said paving job; and
assisting said paving vehicle or said operator of said vehicle by making said generated feedback data available.

2. The method according to claim 1, wherein said paving best practices data comprises data relating to defined paving requirements, and wherein said algorithm involves processing said job data and said defined paving requirements to generate feedback data.

3. The method according to claim 2, wherein said defined paving requirements are generated from an analysis of previous collected job data from paving vehicles, and wherein said algorithm involves processing of said job data and said previous collected job data to generate feedback data.

4. The method according to claim 2, wherein said defined paving requirements are predefined based on existing paving knowledge or known process standards, and wherein said algorithm involves processing of said job data and said existing paving knowledge or known process standards.

5. The method according to claim 1, wherein said feedback data is made available by converting the data to operator instructions and communicating said instructions to said operator during said paving job.

6. The method according to claim 1, wherein said feedback data is made available by converting the data to paving vehicle control data and is provided as control data to said paving vehicle for controlling said paving vehicle.

7. The method according to claim 1, wherein said feedback data is made available by generating paving job recommendation data to be stored at a recommendation database at least being accessible by said operator.

8. The method according to claim 1, wherein said job data includes paving process data identifying a current operating status of the paving vehicle.

9. The method according to claim 1, wherein said job data comprises external paving process data identifying external factors influencing the paving job.

10. The method according to claim 1, wherein said job data includes paving process data identifying a quality of the paving layer resulting from the paving job performed by said vehicle.

11. A system for assisting a paving vehicle to improve a paving job performed by said vehicle, the system comprising:
receiving means for receiving job data relating to said paving job;
receiving means for receiving paving best practices data;
processing means for processing said job data and said paving best practices data according to an algorithm and based on said processing generating feedback data for improving said paving job; and
assisting means for assisting said paving vehicle or said operator of said vehicle by making said generated feedback data available.
